(19) United States
(12) Patent Application Publication
(10) Pub. No.: US 2013/0179816 A1
(43) Pub. Date: Jul. 11, 2013

(54) USER TERMINAL APPARATUS AND CONTROLLING METHOD THEREOF

(71) Applicant: SAMSUNG ELECTRONICS CO., LTD., Suwon-si (KR)

(72) Inventors: Joon-kyu SEO, Suwon-si (KR); Hyun-jin KIM, Seoul (KR); Ji-yeon KWAK, Seoul (KR); Sang-keun JUNG, Suwon-si (KR); Kyung-a KANG, Seoul (KR)

(73) Assignee: SAMSUNG ELECTRONICS CO., LTD., Suwon-si (KR)

(21) Appl. No.: 13/735,440

(22) Filed: Jan. 7, 2013

Related U.S. Application Data
(60) Provisional application No. 61/583,834, filed on Jan. 6, 2012.

(30) Foreign Application Priority Data
Oct. 30, 2012 (KR) 10-2012-0121519

(51) Int. Cl. G06F 3/0484

(52) U.S. Cl. CPC G06F 3/04842
USPC 715/770

(57) ABSTRACT

A user terminal apparatus and controlling method thereof are provided. The user terminal apparatus includes a display unit which displays a screen including a first area including at least one object and a second area to perform editing using the at least one object, a user interface unit which receives a user command to copy the object displayed in the first area to the second area, and a controller which, in response to the received user command, controls to automatically copy the object to a location within the second area which corresponds to an attribute of the object based on the attribute of the object.

### CROSS-REFERENCE TO RELATED APPLICATIONS

This application claims priority from Korean Patent Application No. 10-2012-0121519, filed in the Korean Intellectual Property Office on Oct. 30, 2012, and U.S. Provisional Application No. 61/583,834, filed in the U.S. Patent and Trademark Office on Jan. 6, 2012, the disclosures of which are incorporated herein by reference.

### BACKGROUND

1. Field

Apparatuses and methods consistent with exemplary embodiments relate to a user terminal apparatus and a controlling method thereof, and more particularly, to a touch-based user terminal apparatus and a controlling method thereof.

2. Description of the Related Art

With developments of electronic technology, various types of display apparatuses have been developed. In particular, display apparatuses such as televisions (TVs), personal computers (PCs), laptop computers, tablet PCs, mobile phones, MP3 players, etc. have been widely distributed and used by consumers.

Recently, in order to meet user needs for more advanced and diverse functions, various ways to provide user convenience for manipulation in various touch-based devices such as tablet PCs, mobile phones, etc. have been suggested.

In particular, as various screen editing functions are provided in a touch-based device, a method for performing copying and pasting functions more easily is needed.

### SUMMARY

Exemplary embodiments provide a user terminal apparatus which determines a location for copying an object based on the attribute of the object and performs a pasting operation accordingly, and a controlling method thereof.

According to an aspect of an exemplary embodiment, there is provide a user terminal apparatus including: a display unit which displays a screen including a first area including at least one object and a second area to perform an editing using the at least one object, a user interface unit which receives a user command to copy the object displayed in the first area to the second area, and a controller which, in response to the user command, controls to automatically copy the object to a location within the second area which corresponds to an attribute of the object based on the attribute of the object.

The second area may include a plurality of block areas having different attributes, and the controller, if the object is moved to the second area according to the user command, may control to automatically copy and position the object in a block area which corresponds to the attribute of the object from among the plurality of block areas.

Each of the plurality of block areas may have predetermined format information, and the controller, if the object is automatically positioned in the block area, may change and display a format of the object according to predetermined format information of a corresponding block area.

The user command may be a user manipulation of touching the object and dragging the object to the second area.

The controller, if the object is moved to a block area within the second area which does not correspond to an attribute of the object according to the user command, may control to automatically move and position the object on in a block area which corresponds to the attribute of the object.

The controller, if there are a plurality of block areas which correspond to an attribute of the object, may control to automatically position the object to a block area closest to a location where the object is moved according to the user command.

If a plurality of objects which are selected simultaneously on the first area move to the second area according to the user command, the controller may control such that each of the plurality of objects are positioned in each of a plurality of block areas of which attributes correspond to each of the plurality of objects, respectively.

The user command to select a plurality of objects may be one of a multi-touch input with respect to each of the plurality of objects and a touch input to select a scope encompassing the plurality of objects.

An attribute of the object may include at least one of an image attribute, a text attribute, a list attribute, and a moving image attribute.

According to an aspect of another exemplary embodiment, there is provide a method for controlling a user terminal apparatus, the method including displaying a screen including a first area including at least one object and a second area to perform editing using the at least one object, receiving a user command to copy the object displayed on the first area to the second area, and in response to the received user command, automatically copying the object to a location within the second area which corresponds to an attribute of the object based on the attribute of the object.

The second area may include a plurality of block areas having different attributes, and the automatically copying the object may include, if the object is moved to the second area according to the user command, automatically copying and positioning the object in a block area which corresponds to the attribute of the object from among the plurality of block areas.

Each of the plurality of block area may have predetermined format information, and the method may further include, if the object is automatically positioned in the block area, changing and displaying a format of the object according to predetermined format information of a corresponding block area.

The user command may be a user manipulation of touching the object and dragging the object to the second area.

The automatically copying the object may include, if the object is moved to a block area within the second area which does not correspond to an attribute of the object according to the user command, automatically moving and positioning the object to a block area which corresponds to the attribute of the object.

The automatically copying the object may include, if there are a plurality of block areas which correspond to an attribute of the object, automatically positioning the object to a block area closest to a location where the object is moved according to the user command.

The automatically copying the object may include, if a plurality of objects which are selected simultaneously on the first area move to the second area according to the user command, controlling such that each of the plurality of objects are positioned in each of a plurality of block areas of which attributes correspond to each of the plurality of objects, respectively.

The user command to select a plurality of objects may be one of a multi-touch input with respect to each of the plurality of objects and a touch input to select a scope encompassing the plurality of objects.

An attribute of the object may include at least one of an image attribute, a text attribute, a list attribute, and a moving image attribute.

### BRIEF DESCRIPTION OF THE DRAWINGS

The above and/or other aspects will be more apparent by describing certain exemplary embodiments with reference to the accompanying drawings, in which:

FIGS. 1A and 1B are views provided to explain a user terminal apparatus according to an exemplary embodiment;

FIG. 2 is a block diagram illustrating specific configuration of the user terminal apparatus in FIG. 1 according to an exemplary embodiment;

FIG. 3 is a view provided to explain configuration of software stored in a storage unit;

FIGS. 4A and 4B are views provided to explain a method for entering into a screen editing mode according to various exemplary embodiments;

FIG. 5 is a view provided to explain a method for providing a template for screen editing according to an exemplary embodiment;

FIGS. 6 to 8 are views provided to explain an editing method using an object according to various exemplary embodiments;

FIGS. 9A, 9B and 10 are views provided to explain an editing method using an object by taking examples according to various exemplary embodiments; and

FIG. 11 is a flowchart provided to explain a method for controlling a user terminal apparatus according to an exemplary embodiment.

### DETAILED DESCRIPTION

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

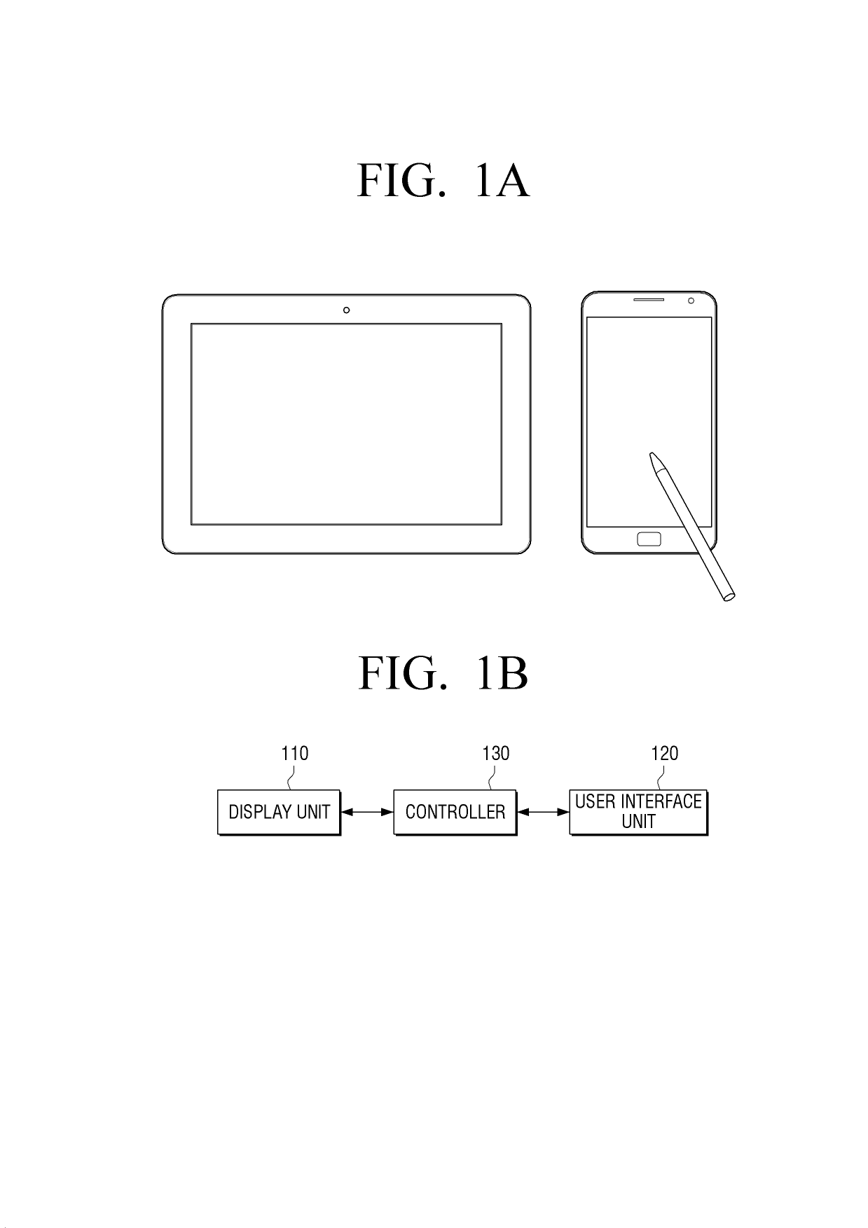

FIGS. 1A and 1B are views provided to explain a user terminal apparatus according to an exemplary embodiment.

FIG. 1A is a schematic view provided to explain an example of realizing a user terminal apparatus according to an exemplary embodiment.

A user terminal apparatus 100 may display a plurality of windows on a screen simultaneously. For example, the user terminal apparatus 100 may display a plurality of application windows in a multi-tasking environment where a plurality of application are executed simultaneously to perform a job.

Specifically, the user terminal apparatus 100 may display a window (for example, a web page, a photo image, etc.) including various objects such as an image, text, a video, a list, etc. according to a user command and a window for composing an editing screen using the objects included in the corresponding screen simultaneously on the screen. Hereinafter, various exemplary embodiments will be explained based on a block diagram illustrating configuration of a user terminal apparatus.

FIG. 1B is a block diagram illustrating configuration of a user terminal apparatus according to an exemplary embodiment.

According to FIG. 1B, the user terminal apparatus 100 includes a display unit 110, a user interface unit 120, and a controller 130.

The display unit 110 displays a screen. Herein, the screen may include an image, a text, a video, a list, and so on.

In particular, the display unit 110 may display a screen including a first area including various objects such as an image, text, a video, a list, etc. according to a user command and a second area for composing an editing screen using the objects included in the first area. Hereinafter, such a screen mode will be referred to as a screen editing mode. Herein, the first area and the second area may be realized in a window form according to execution of each application, and location and size of each window may be adjusted. In addition, each window may include a title area (or a title bar) including various menu items. Specifically, a maximization button, an end button, a pin-up button, and etc. may be provided in the title area. Accordingly, a window maximization command, a window end command, a window pin-up command, and etc. may be input through manipulation of each button.

However, the screen displayed in the first and the second areas are not necessarily realized in a window form, and may be divided and displayed in a single window.

The display unit 110 may be realized as a Liquid Crystal Display Panel (LCD), Organic Light Emitting Diode (OLED) display, and so on, but is not limited thereto. In particular, the display unit 110 may be implemented in a touch screen form which forms a interlayer structure with a touch pad. In this case, the display unit 110 may be used not only an output apparatus but also as the user interface unit 120 which will be explained later. Herein, the touch screen may be configured to detect not only location and size of a touch input but also pressure of a touch input.

The user interface unit 120 receives various user commands.

In particular, the user interface unit 120 may receive a user command to enter into the above-mentioned screen editing mode. For example, the user interface mode 120 may enter into a screen editing mode through a manipulation of a button to enter into a screen editing mode formed on a window including various objects such as a web page or a manipulation of reducing the size of a window by touch-and-drag of a predetermined area on a window.

In addition, the user interface unit 120 may receive various user commands for screen editing in a screen editing mode. For example, the user interface unit 120 may receive a manipulation input of touch-and-drag in order to select an object and move the selected object to an area where the object is to be copied on a web page.

The controller 130 controls overall operations of the user terminal apparatus 100.

If a user command to copy an object displayed on the first area of the display unit 110 on the second area is input, the controller 130 may copy the object selected by the user command from among objects displayed on the first area and paste the selected object on the second area. For example, a web page including an image, text, a video, a list, etc. may be displayed, and a page for composing an editing screen using the objects included in the web page may be displayed.

In particular, the controller 130 may control such that an object may be automatically copied and positioned on an area of the second area having an attribute corresponding to that of the object based on attribute information of the object selected by the user command on the first area. Herein, the object attribute may include at least one of an image attribute, a text attribute, list attribute, and a video attribute, but is not limited thereto.

The second area may be divided into a plurality of block areas having different attributes. For example, second area may include at least one of a first block area having an image attribute, a second block area having a text attribute, a third block area having a list attribute, and a fourth block area having a video attribute. In addition, format information may be preset in each block area. For example, in the case of the second block area, “Times New Roman, font 12” may be set.

In this case, if the object selected in the first area is moved to the second area according to a user command, the controller 130 may control such that the object may be automatically positioned on a block area of the second area having an attribute corresponding to that of the selected object from among a plurality of predetermined block areas. Herein, the user command may be a user manipulation of touching an object in the first area and dragging the touched object to the second area.

That is, if the object selected in the first area is moved to an area of the second area having an attribute that does not correspond to that of the selected object according to a user command, the controller 130 may control such that the object may be automatically moved and positioned on the nearest area having an attribute corresponds to that of the object.

In addition, if the object is automatically positioned on a specific area of the second area according to the attribute, the format and graphic effect of the object may be changed and displayed according to the predetermined format information set in the corresponding block area.

For example, if a text which is displayed in “Verdana, font 10” on the first is copied and positioned on a specific text block area of the second area having the format information “Times New Roman, font 12”, the text positioned on the corresponding text block area may be changed to “Times New Roman, font 12” and then displayed.

In addition, if there are a plurality of block areas of the second area corresponding to the attribute of the object selected in the first area according to a user command, the controller 130 may control such that the object may be automatically positioned on the block area which is the nearest to a location where the selected object is moved. For example, if the object has an image attribute, the controller 130 calculates a distance between a center point of the corresponding image at a location where the corresponding image is moved and a center point of a plurality of block areas having the image attribute, and controls such that the corresponding image may be automatically positioned on a block area which is the nearest to the center point of the corresponding image. However, this is only an example, and the distance between an object and a block area may be calculated in various ways. For example, a distance between one edge (or one side) of the corresponding image and an edge corresponding to the corresponding edge (or one side) of a plurality of block areas having the image attribute may be calculated.

Further, if a plurality of objects selected in the first area simultaneously are moved to the second area according to a user command, the controller 130 may control such that the plurality of objects may be automatically positioned on a plurality of block areas corresponding to attributes of the plurality of objects, respectively. Herein, the user command to select a plurality of objects simultaneously may be one of multi-touch inputs regarding each of the plurality of objects or panning manipulation of selecting the scope including the plurality of objects.

For example, if a first object having an image attribute and a second object having a text attribute on a web page displayed on the first area are moved to an editing page displayed on the second area through multi-touch and drag manipulation, the first object may be automatically moved and positioned on the first block area having an image attribute and the second object may be automatically moved and positioned on the second block area having a text attribute.

In addition, the controller 130 may adjust the size and shape of an object based on the size and shape of a block area where the object copied from the first area to the second area is positioned. For example, if the object has an image attribute, the size and resolution of the image may be adjusted and displayed based on the size of the block area, and if the object has a text attribute, the size of the text may be adjusted and displayed based on the size of the block area.

In addition, the controller 130 may display a menu to place the object copied on the second area or to change the shape of the object according to the attribute of the object on the corresponding block area or on an area closest to the corresponding block area. For example, if the object has a text attribute, the controller 130 may display a menu to change the size or shape of the text on the block area in an overlapping manner. Accordingly, a user may edit the object which is copied from the first area to the second area to be in a desired form.

Further, the controller 130 may control such that a menu to select various types of templates which predefine various editing layouts provided in a screen editing mode are displayed on the second area. For example, if the corresponding menu is selected, the controller 130 may display a plurality of templates which briefly show various predefined layouts to allow a user to select a desired template.

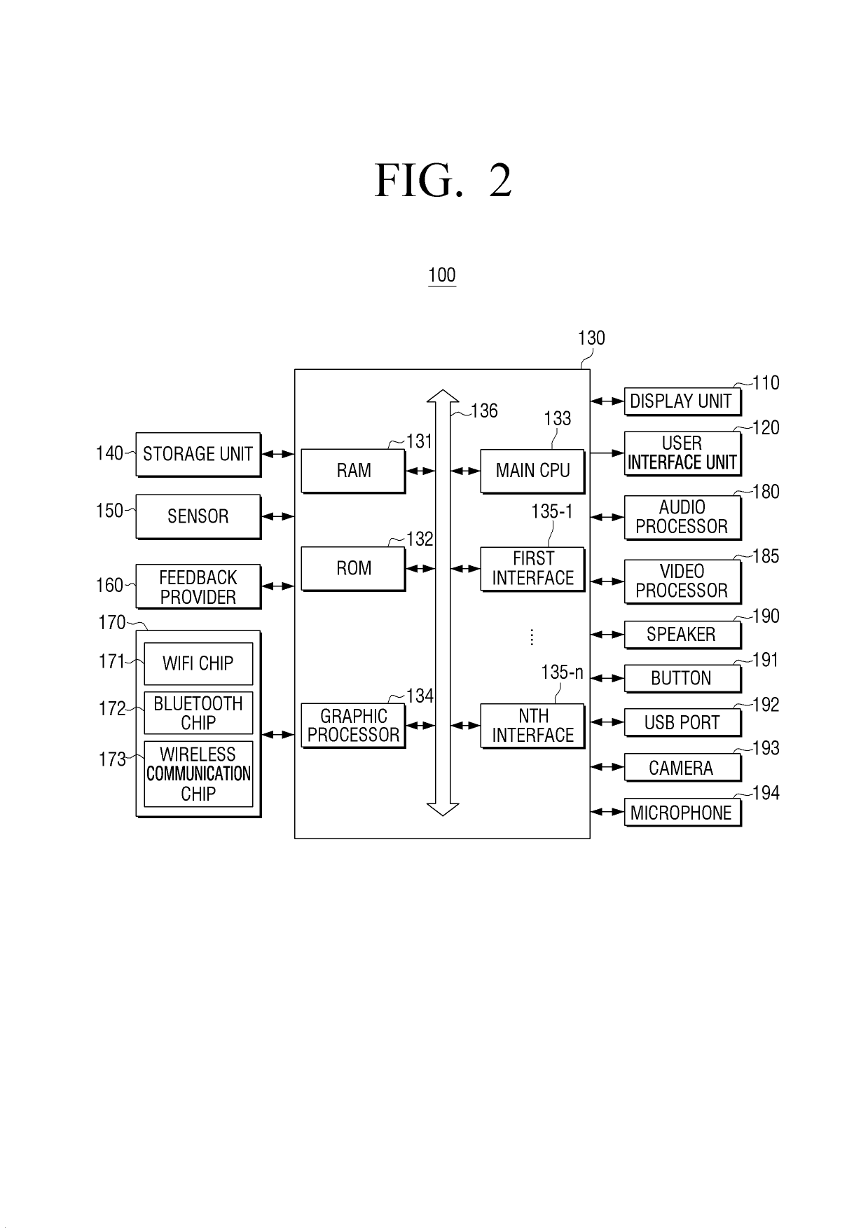

FIG. 2 is a block diagram illustrating specific configuration of the user terminal apparatus in FIG. 1 according to an exemplary embodiment. Referring to FIG. 2, the user terminal apparatus 100 comprises the display unit 110, the user interface unit 120, and the controller 130, a storage unit 140, a sensor 150, a feedback provider 160, a communication unit 170, an audio processor 180, a video processor 185, a speaker 190, a button 191, a Universal Serial Bus (USB) port 192, a camera 193, and a microphone 194. From among the components illustrated in FIG. 2, those components which are overlapped with the components illustrated in FIG. 1B will not be explained in detail.

The above-described operations of the controller 130 may be performed by a program stored in the storage unit 140. The storage unit 140 may store various data such as an Operating System (O/S) software module for driving the user terminal apparatus 100, various applications, and various data and contents which are input or set during execution of an application.

In addition, the storage unit 140 may store various types of templates which define various editing layouts provided in a screen editing mode.

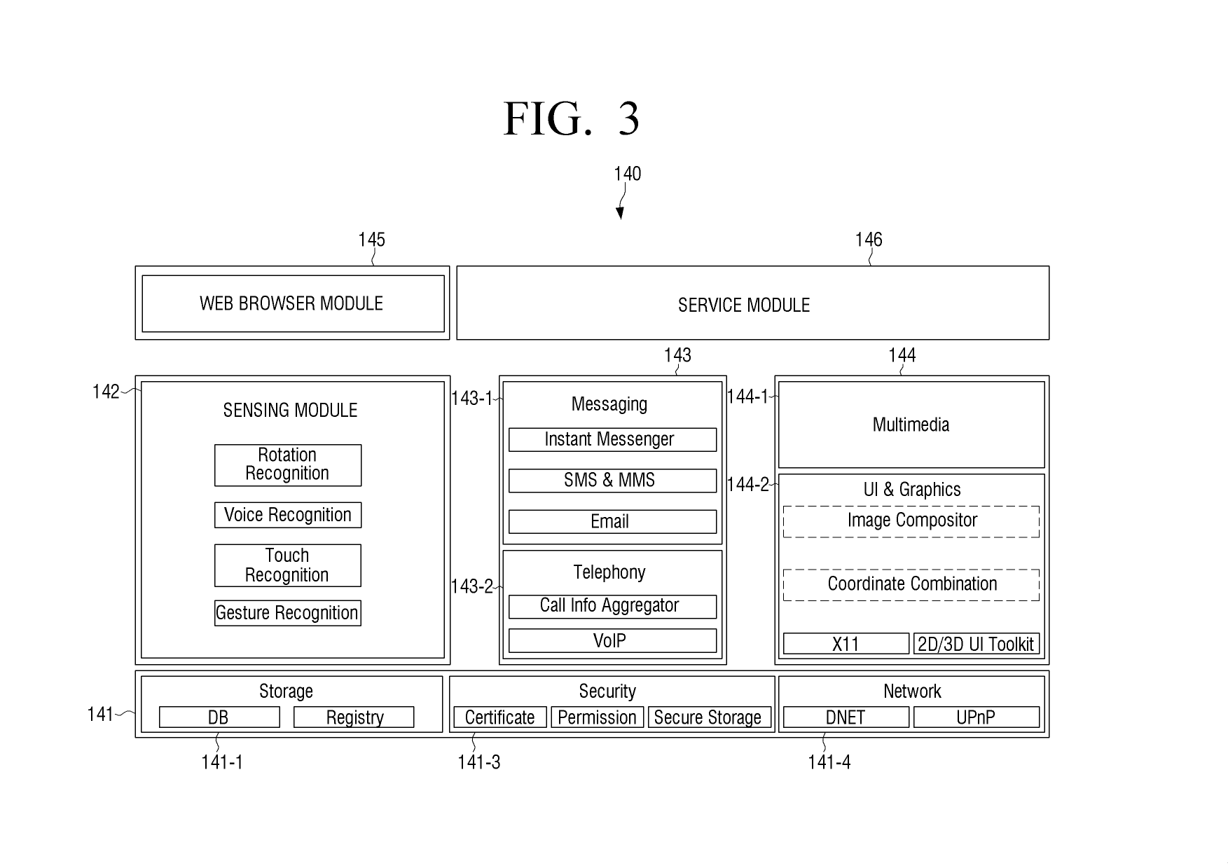

Various software modules stored in the storage unit 140 will be explained later with reference to FIG. 3.

The sensor 150 may sense various manipulations such as touch, rotation, tilt, pressure, approach, and so on.

In particular, the sensor 150 may include a touch sensor which senses a touch. The touch sensor may be realized as capacitive or resistive sensor. The capacitive sensor calculates touch coordinates by sensing micro-electricity excited by a user body when part of the user body touches the surface of the display unit 110 using a dielectric coated on the surface of the display unit 110. The resistive sensor comprises two electrode plates, and calculates touch coordinates as the upper and lower plates of the touched point contact with each other to sense flowing electric current when a user touches a screen. As such, a touch sensor may be realized in various forms, and as described above, a touch sensor may sense a touch (or multi-inch) which is a user command to copy an object and drag manipulation.

In addition, the sensor 150 may further comprise a geomagnetic sensor to sense a rotation and a motion direction of the user terminal apparatus 100 and an acceleration sensor to sense a degree of tilt of the user terminal apparatus 100.

The feedback provider 160 provides various feedback according to the functions executed by the user terminal apparatus 100.

In particular, the feedback provider 160 may provide haptic feedback regarding a touch manipulation on a screen and a graphic user interface (GUI) displayed on the screen. Herein, the haptic feedback is a technology which senses a user touch by causing shock such as vibration or force on the user terminal apparatus 100 and is also referred to as a computer sensing technology.

For example, if a plurality of objects are selected on the first area through a multi-touch manipulation by a user, the feedback provider 160 may provide haptic feedback regarding the corresponding multi-touch manipulation. In addition, if an object is selected on the first area by a user manipulation and a GUI or a highlight area to identify the selected object from other objects is provided, the feedback provider 160 may provide haptic feedback regarding the corresponding GUI or the highlight area.

In this case, the feedback provider 160 may provide various feedback by applying different vibration conditions (such as, vibration frequency, vibration length, vibration strength, vibration wave form, vibration location, and so on) under the control of the controller 130. A detailed description regarding the method for generating various haptic feedback by applying different vibration conditions will not be provided since the method in known in the related art.

In the above exemplary embodiment, the feedback provider 160 provides haptic feedback using a vibration sensor, but this is only an example. For example, the feedback provider 160 may provide haptic feedback using a piezo sensor.

The communication unit 170 performs communication with various types of external apparatuses according to various types of communication methods. The communication unit 170 comprises various communication chips such as a WiFi chip 171, a Bluetooth chip 172, and a wireless communication chip 173.

The WiFi chip 171 and the Bluetooth chip 172 perform communication using a WiFi method and a Bluetooth method, respectively. The wireless communication chip 173 refers to a chip which performs communication according to various communication standards such as IEEE, Zigbee, 3rd Generation (3G), 3rd Generation Partnership Project (3GPP), and Long Term Evolution (LTE). In addition, the communication unit 170 may further include a near field communication (NFC) chip. For example, the communication unit 170 may receive a web page including various objects from a web server using the wireless communication chip 173.

The audio processor 180 processes audio data. The audio processor 170 may perform various processing including decoding, amplification, and noise filtering with respect to audio data.

The video processor 185 processes video data. The video processor 185 may perform various processing including decoding, scaling, noise filtering, frame rate conversion, and resolution conversion with respect to video data.

The speaker 190 outputs not only various audio data processed by the audio processor 180 but also various alarm sounds or audio messages, and so on.

The button 191 may be various types of buttons such as a mechanical button, a touch pad, or wheel formed on a certain area of the outer surface of the body of the user terminal apparatus 100, such as the front, side, or rear side of the user terminal apparatus 100. For example, a button for turning on/off power of the user terminal apparatus 100 may be provided.

The USB port 192 may perform communication or perform a charging operation with respect to various external apparatuses through a USB cable.

The camera 193 captures a still image or a moving image under the control of a user. The camera 193 may be realized as a plurality of cameras such as a front camera and a rear camera.

The microphone 194 receives and converts a user voice or other sounds into audio data. The controller 130 may user a user voice input through the microphone 194 during a phone call, or may convert a user voice into audio data and store it in the storage unit 140.

If the camera 193 and the microphone 194 are provided, the controller 130 may perform a control operation according to a user voice input through the microphone 194 or a user motion which is recognized through the camera 193. That is, the user terminal apparatus 100 may operate in a motion control mode or in a voice control mode. If the user terminal apparatus 100 operates in a motion control mode, the controller 130 activates the camera 193 to photograph a user and performs a control operation by tracing the change of motion of the user. If the user terminal apparatus 100 operates in a voice control mode, the controller 130 analyzes a user voice input through the microphone 194 and performs a control operation according to the analyzed user voice.

In addition, various external input ports such as a headset, a mouse, and local area network (LAN) port may be further included in order to connect to various external terminals.

The controller 130 controls overall operations of the user terminal apparatus 100 using various programs stored in the storage unit 140.

For example, the controller 130 may execute an application stored in the storage unit 140 to configure and display its execution screen or reproduce various contents stored in the storage unit 140. Further, the controller 130 may perform communication with external apparatuses through the communication unit 160.

Specifically, the controller 130 includes a random access memory (RAM) 131, a read only memory (ROM) 132, a main central processing unit (CPU) 133, a graphic processor 134, a first to nth interfaces 135-1˜135-n, and a bus 136.

The RAM 131, the ROM 132, the main CPU 133, the graphic processor 134, and the first to nth interfaces 135-1˜135-n may be connected to each other through the bus 136.

The first to nth interfaces 135-1˜135-n are connected to the above-described various components. One of the interfaces may be a network interface which is connected to an external apparatus via a network.

The main CPU 133 accesses the storage unit 140 and performs booting using an O/S stored in the storage unit 140, and performs various operations using various programs, contents, and data stored in the storage unit 140.

The ROM 132 stores a set of commands for system booting. If a turn-on command is input and power is supplied, the main CPU 133 copies an O/S stored in the storage unit 140 onto the RAM 131 according to a command stored in the ROM 132 and boots a system by executing the O/S. If the booting is completed, the main CPU 133 copies various application programs stored in the storage unit 140 into the RAM 131 and performs the various operations by executing the application programs copied in the RAM 131.

The graphic processor 134 generates a screen including various objects such as an icon, an image, and text using a computing unit (not shown) and a rendering unit (not shown). The computing unit computes property values such as coordinates, shape, size, and color of each object to be displayed according to the layout of the screen using a control command received from the input apparatus 134. The rendering unit generates a screen with various layouts including objects based on the property values computed by the computing unit. The screen generated by the rendering unit is displayed within the display area of the display unit 110.

Although not illustrated in the drawing, the user terminal apparatus 100 may further include an application driving unit.

The application driving unit drives and executes an application which can be provided by the user terminal apparatus 100. Herein, the application refers to an application program which can be executed by itself, and may include various multi-media contents. Herein, ‘the multi-media contents’ include text, audio, still image, animation, video, interactive contents, Electronic Program Guide contents provided by content providers, electronic message received from users, information regarding current events, and so on, but are not limited thereto.

In particular, the application driving unit may drive an application to provide a screen editing mode according to an exemplary embodiment in response to a user command. That is, a service for providing a screen editing mode according to an exemplary embodiment may be realized in the form of a software application which is used directly by a user on O/S. In this case, the application may be provided in the form of icon interface on the screen of the user terminal apparatus 100, but is not limited thereto.

FIG. 2 illustrates an example of specific configuration included in the user terminal apparatus 100, and depending on the exemplary embodiments, part of the components illustrated in FIG. 2 may be omitted or changed, or other components may be added. For example, the user terminal apparatus may further include a global positioning service (GPS) receiver (not shown) to calculate the current location of the user terminal apparatus 100 by receiving a GPS signal from a GPS satellite and a Digital Multimedia Broadcasting (DMB) receiver (not shown) to receive and process a DMB signal.

FIG. 3 is a view provided to explain configuration of software stored in the storage unit 140.

Referring to FIG. 3, the storage unit 140 may store software including a base module 141, a sensing module 142, a communication module 143, a presentation module 144, a web browser module 145, and a service module 146.

The base module 141 refers to a basic module which processes a signal transmitted from each hardware included in the user terminal apparatus 100 and transmits the processed signal to an upper layer module. The base module 141 includes a storage module 141-1, a security module 141-2, a network module 141-3, and so on. The storage module 141-1 is a program module which manages database (DB) or registry. The main CPU 133 may read our various data by accessing database in the storage unit 140 using the storage module 141-1. The security module 141-2 is a program module which supports certification, permission, secure storage, and etc. with respect to hardware, and the network module 141-3 is a module to support network connection and includes a DNET module, UPnP module, and so on.

The sensing module 142 collects information from various sensors and analyzes and manages the collected information. The sensing module 142 may include face recognition module, voice recognition module, motion recognition module, NFC recognition module, and so on.

The communication module 143 performs communication with external apparatuses. The communication module 143 may include a messaging module 143-1 such as messenger program, a Short Message Service (SMS) & Multimedia Message Service (MMS) program and an e-mail program and a telephone module 143-2 including a Call Info Aggregator program module, a VoIP module, and so on.

The presentation module 144 composes a display screen. The presentation module 144 may include a multi-media module 144-1 to generate and output multi-media contents and a User Interface (UI) rendering module 144-2 to perform UI and graphic processing. The multi-media module 144 may include a player module, a camcorder module, a sound processing module, and so on. Accordingly, the presentation module 144 generates and reproduces screen and sound by reproducing various multi-media contents. The UI rendering module 144-2 may include an image compositor module to composite images, a coordinates combination module to combine and generate coordinates on the screen where an image is displayed, an X11 module to receive various events from hardware, and a 2D/3D UI toolkit to provide a tool to compose a 2D or 3D UI.

The web browser module 145 accesses a web server by performing web browsing. The web browser module 145 may include various modules such as a web view module to compose a web page, a download agent module to perform downloading, a bookmark module, a web-kit module, and so on.

The service module 146 includes various applications to provide various services. Specifically, the service module 146 may include various program modules such as a navigation program, a content reproduction program, a game program, an electronic book program, a calendar program, an alarm management program, other widgets, and so on.

FIG. 3 illustrates various program modules, but some of the program modules may be omitted or changed, or other program modules may be added according to type and characteristics of the user terminal apparatus 100. For example, a location-based module which supports a location-based service in association with hardware such as a GPS chip may be further included.

Hereinafter, a UI providing method according to various exemplary embodiments will be explained in greater detail with reference to drawings.

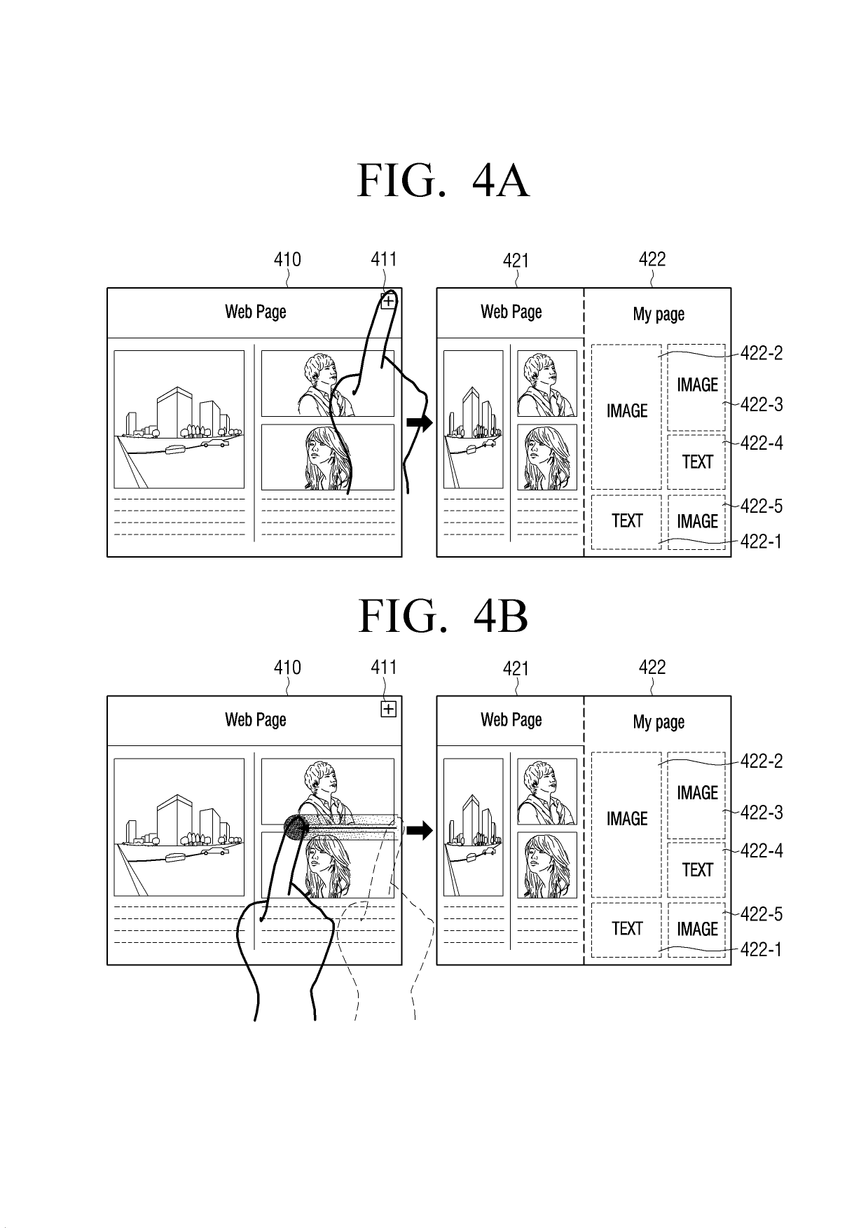

FIGS. 4A and 4B are views is a view provided to explain a method for entering into a screen editing mode according to various exemplary embodiments.

According to an exemplary embodiment, as illustrated in FIG. 4A, if a menu button 411 which is formed on the screen to enter into a screen editing mode is selected while a web page 410 including an image and text is displayed on the screen, an editing page to perform editing using the image and the text included in the corresponding web page may be further displayed.

Specifically, the web page displayed on the entire screen may be displayed on the first area 421 of the screen and the editing page may be displayed on the second area 422 of the screen. In this case, the editing page displayed on the second area 422 may have a predetermined layout. For example, as illustrated in the drawing, the editing page may have a layout format including text block areas 422-1, 422-4 where an object having text attribute is positioned and image block areas 422-2, 422-3, 422-5 where an object having image attribute is positioned.

According to another exemplary embodiment, as illustrated in FIG. 4B, if a user manipulation of touching one side area of the web page 410 and dragging it in the left direction while the web page 410 including an image and a text is displayed on the screen menu button 411 which is formed on the screen to enter into a screen editing mode is selected while a web page 410 including an image and a text is displayed on the screen, the size of the web page 410 is reduced and displayed according to the corresponding touch and drag manipulation, and an editing page to perform editing using the image and the text included in the corresponding web page may be further displayed on the remaining area.

Although not illustrated in the drawing, the above-described screen editing mode may be performed while the screen editing mode is turned “on” in a separate setting menu or while an application to provide the corresponding service is executed.

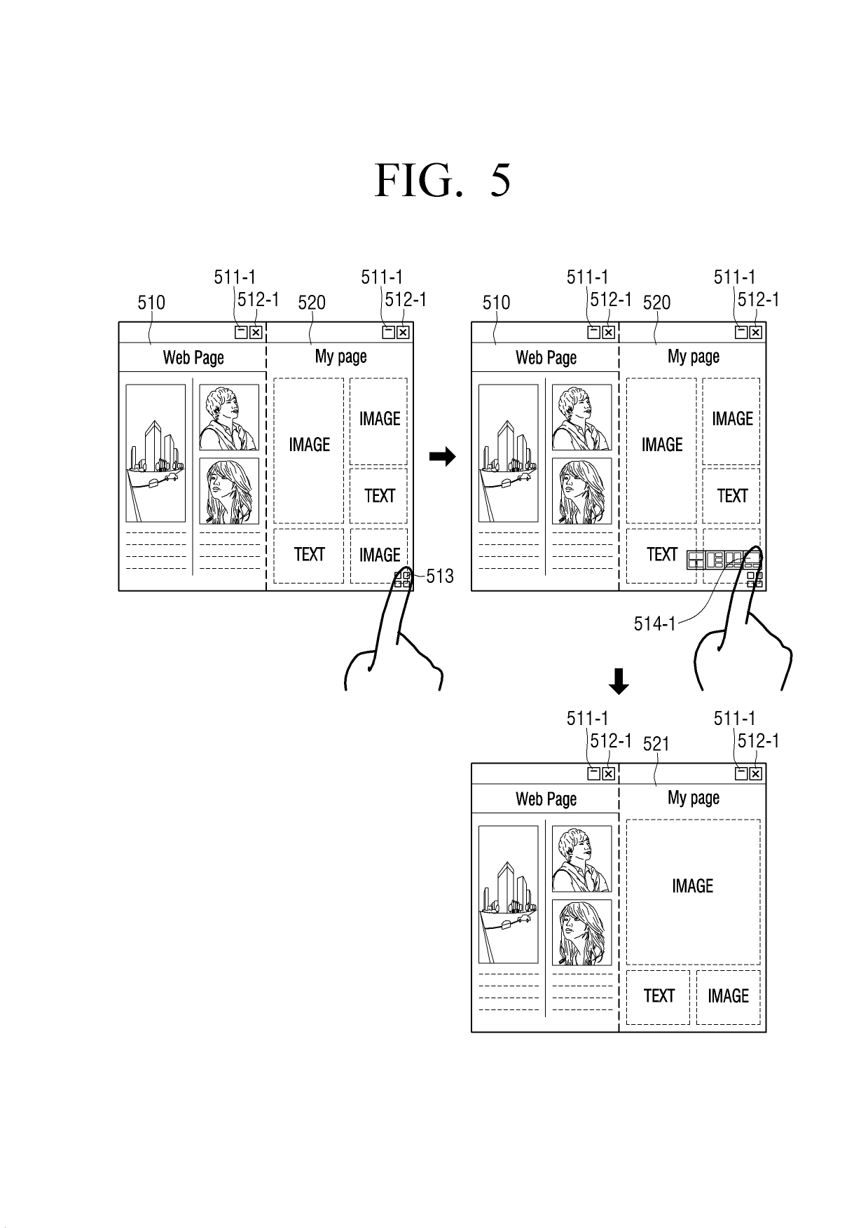

FIG. 5 is a view provided to explain a method for providing a template for screen editing according to an exemplary embodiment.

As illustrated in FIG. 5, a web page 510 may be displayed on the first area of the screen, an editing page 520 may be displayed on the second area, and a menu button 513 to select a layout for editing may be displayed on the editing page 520. In some cases, as illustrated in the drawing, a button 511-1 to maximize the size of the corresponding window and a button 512-1 to end the corresponding window may be further included on the web page 510 and the editing page 520.

If the menu button 513 formed on the editing page 520 is selected, a plurality of predetermined template menus 514 may be displayed on an area closest to the menu button 513.

Subsequently, if one menu 514-2 is selected from among a plurality of template menus 514, an editing page 521 to define a layout according to the selected template 514-1 may be displayed on the second area.

That is, a user may change a layout for configuring an editing page through a menu button providing templates.

However, the exemplary embodiment illustrated in FIG. 5 is only an example, and the layout of the editing page may be changed in various ways. For example, an editing page may be changed to be in a different predetermined layout form through a flick manipulation with respect to the editing page instead of using a separate menu button.

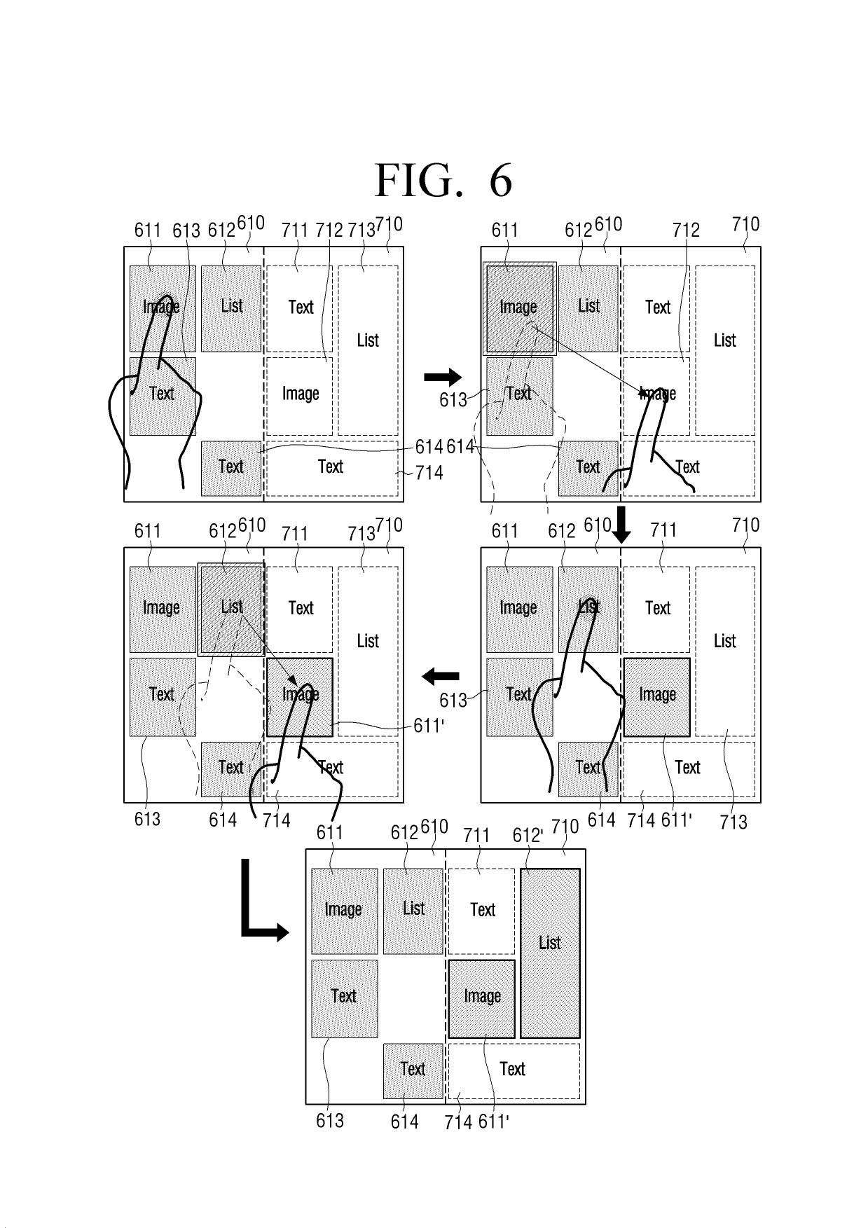

FIGS. 6 to 8 are views provided to explain an editing method using an object according to various exemplary embodiments.

If one object is copied, as illustrated in FIG. 6, an original page 610 including a plurality of objects 611 to 614 may be displayed on the left area of the screen and an editing page 710 to perform an editing using the plurality of objects 611 to 614 included in the original page 610 may be displayed on the right area of the screen. In this case, the editing page 710 may include various block areas such as text blocks 711, 714, an image block 712, a list block 713, and so on.

In accordance with a user manipulation of touching a specific image 611 on the displayed original page 610 and dragging the specific image 611 to the editing page 710 on the second area, the dragged image 611 may be automatically copied and positioned on the image block area 712 corresponding to the attribute of the corresponding image 611. That is, regardless of the location where the user's drag manipulation stops, the image may be copied and positioned on the image block area 712 having image attribute.

Subsequently, in accordance with a user manipulation of touching a specific list 612 on the displayed original page 610 and dragging the specific list 612 to the editing page 710 on the second area, the dragged list 612 may be automatically copied and positioned on the list block area 713 corresponding to the attribute of the corresponding list 612. That is, even if a user's drag manipulation stops on an image block area 611′ where the image 611 is displayed, the list 612 may be copied and positioned on the list block area 712 having a list attribute regardless of the location where the user's drag manipulation stoops.

As illustrated in FIG. 6, if a specific object is selected on the original page 610 by a user's touch manipulation, the selected objects 611, 612 may be displayed in a highlighted form to be distinguished from other objects or a GUI which can be distinguished from other objects may be overlapped and displayed.

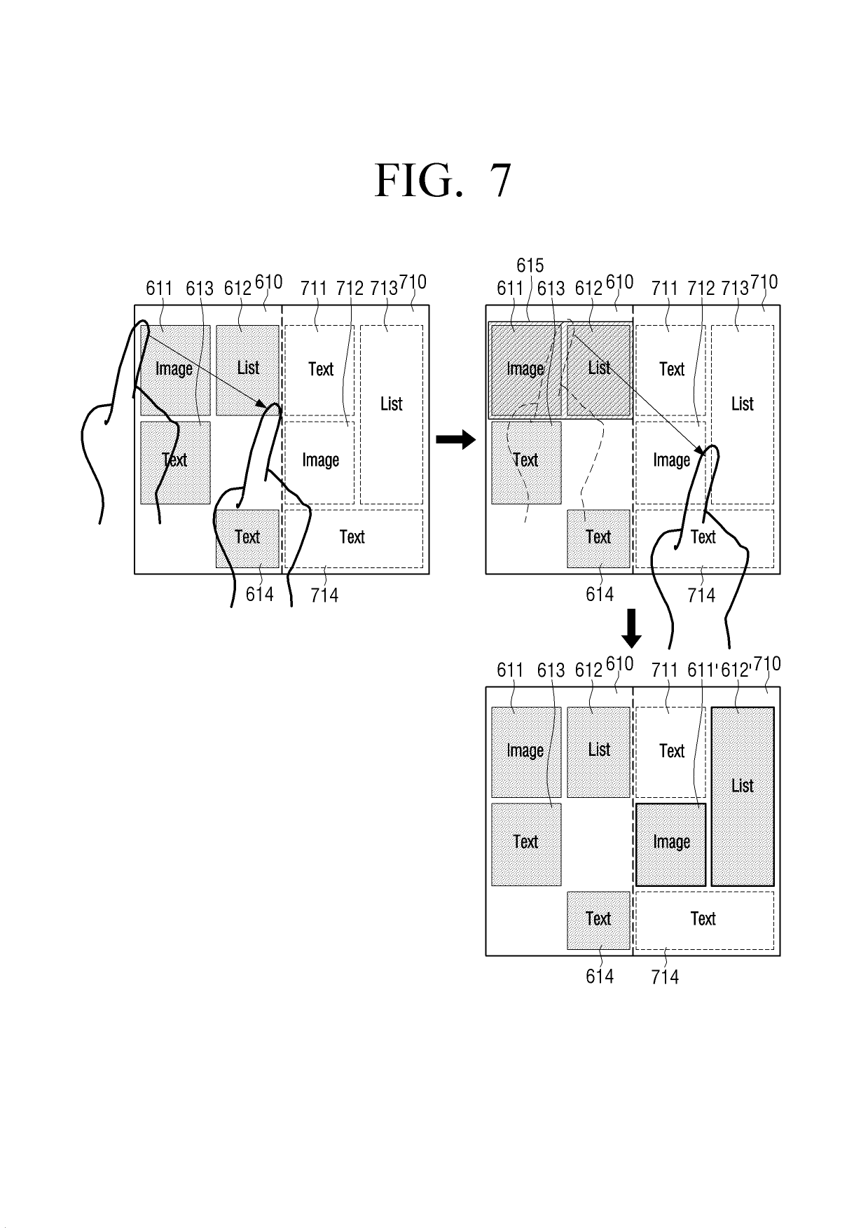

If a plurality of objects are copied simultaneously, as illustrated in FIG. 7, a user may select a plurality of objects by a manipulation of touching one area of a specific object on the original page 510 displayed on the first area and dragging the touched area to one area of another object to be copied. For example, if a user touches an upper left corner area of the object 611 and drags it to a lower right area of the other object 612, the object 611 and the other object 612 are selected, and a GUI 615 indicating that the corresponding objects are selected may be displayed on the object 611 and the other object 612.

In accordance with a user manipulation of dragging the corresponding objects to the editing page 710 on the second area while the GUI 615 is displayed on the object 611 and the other object 612, the selected objects 611, 612 may be copied on the second area. Specifically, the selected objects 611, 612 may be automatically copied to corresponding block areas based on attributes of each of the selected objects 611, 612. For example, the object 611 having image attribute may be positioned on the image block area 712 and the object 612 having list attribute may be positioned on the list block area 713. That is, even if a user's drag manipulation stops between the image block area 712 and the list block area 713, the objects may be copied and positioned on the block areas corresponding the attributes of each object regardless of the location where the user manipulation stops.

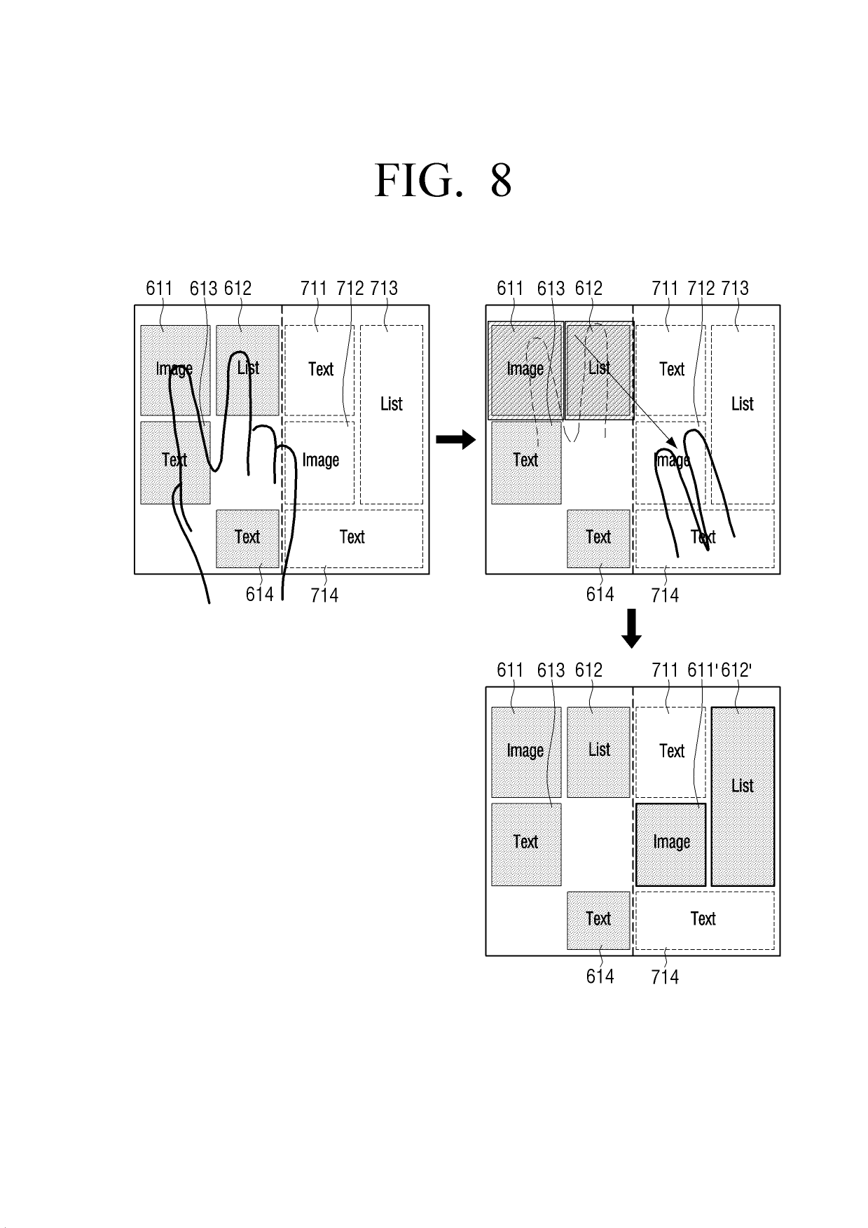

In addition, if a user wishes to copy a plurality of objects simultaneously, as illustrated in FIG. 8, a user may select a plurality of objects by a user manipulation of multi-touching a plurality of objects on the original page 510 displayed on the first area. For example, if the object 611 and the other object 612 are multi-touched, a GUI 615 indicating that the corresponding objects are selected may be displayed on the object 611 and the other object 612.

In accordance with a user manipulation of dragging the corresponding objects to the editing page 710 on the second area while the GUI 615 is displayed on the object 611 and the other object 612, the selected objects 611, 612 may be copied on the second area. Specifically, the selected objects 611, 612 may be automatically copied to corresponding block areas based on attributes of each of the selected objects 611, 612.

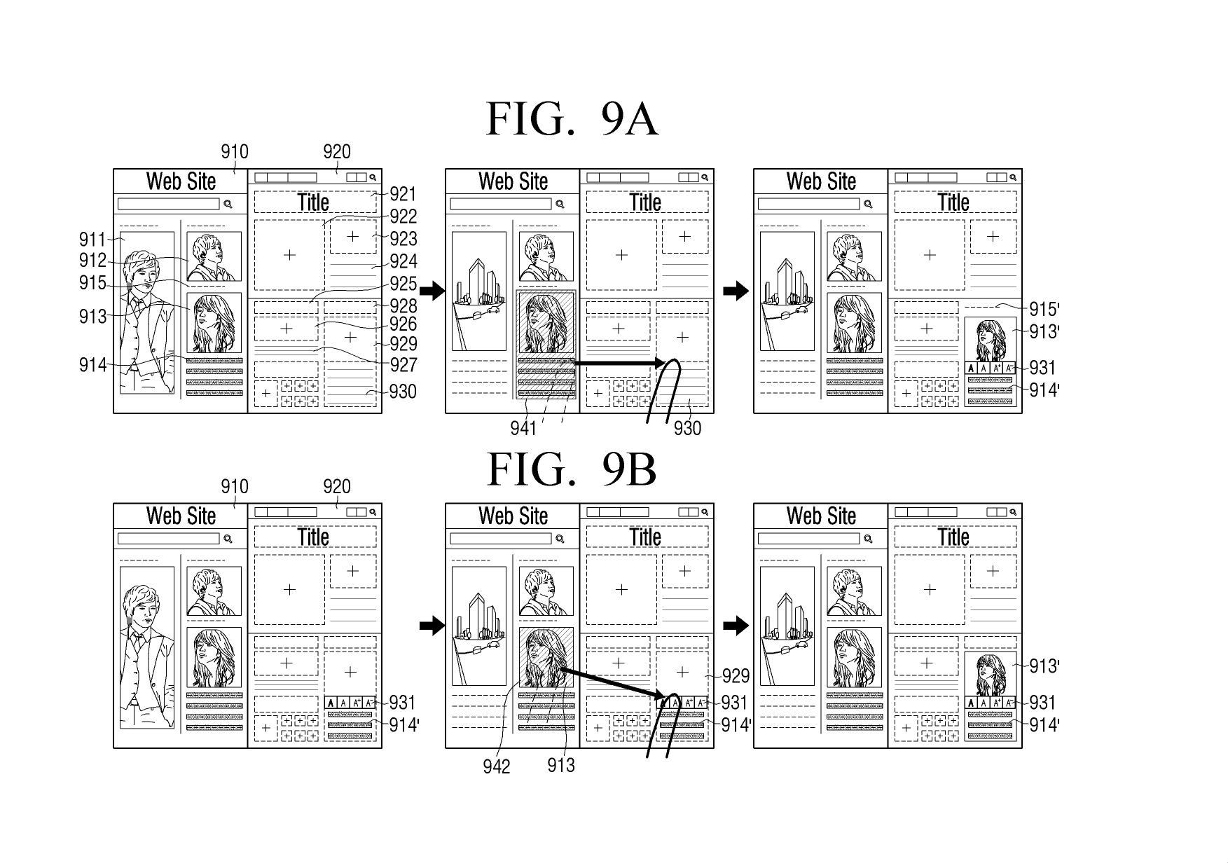

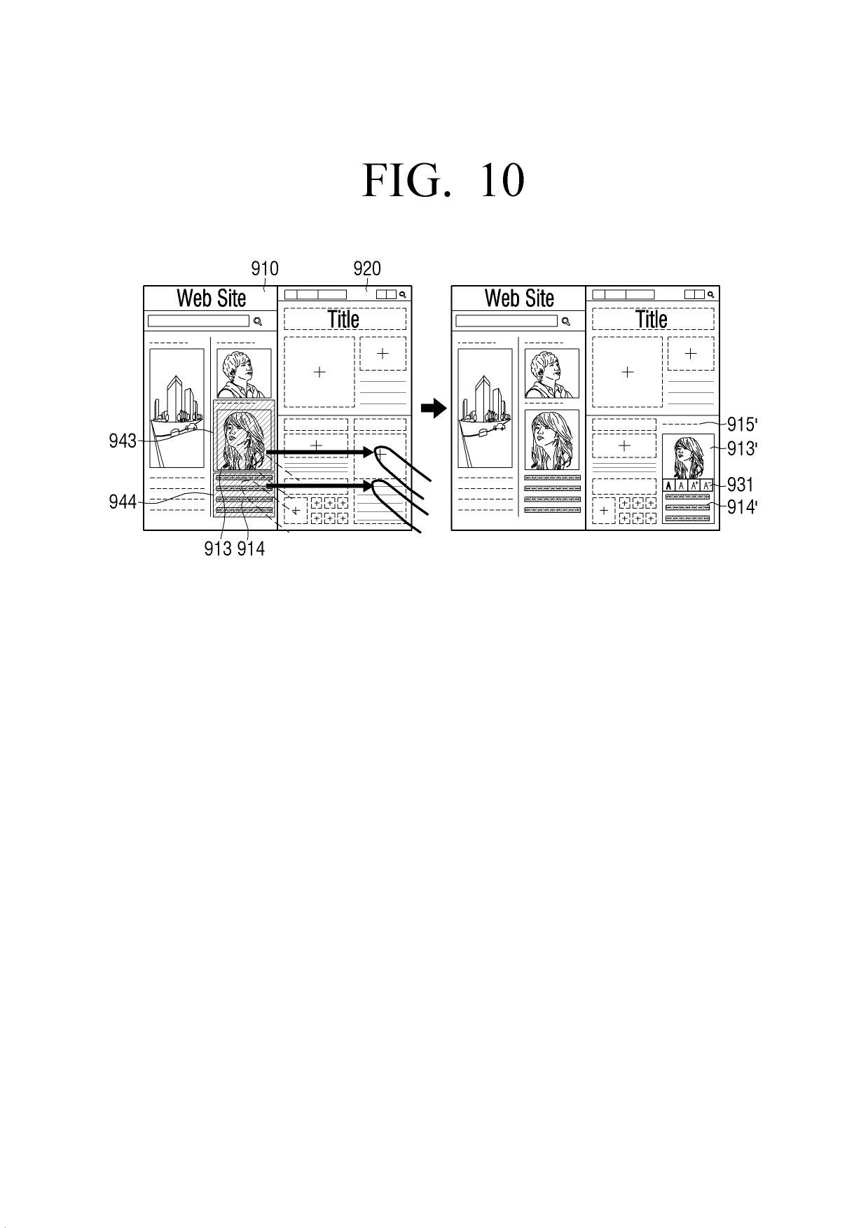

FIGS. 9A, 9B and 10 are views provided to explain an editing method using an object by taking examples according to various exemplary embodiments.

As illustrated in FIG. 9A and FIG. 9B, the corresponding objects may be automatically copied to the corresponding areas based on the attributes of the objects regardless of the location where a drag manipulation regarding the selected objects stops.

As illustrated in FIG. 9A, a web page 910 including images 911, 912, 913 and texts 914, 915 may be displayed on the left area of the screen and an editing page 920 may be displayed on the right area of the screen. In this case, the editing page 920 may include various block areas including title block areas 921, 925, 928, image block areas 922, 923, 926, 929, and text block areas 924, 927, 930.

If the image 913 and the text 914 corresponding to the 913 are selected on the web page 910 by a touch manipulation, a GUI 930 indicating that the text 914 is selected is displayed. Subsequently, in accordance with a user manipulation of the image 913 and the text 914 to the editing page 914 while the corresponding GUI 930 is displayed, the image 913 and the text 914 may be automatically copied on the image block area 929 and the text block area 930 (913′, 914′). In addition, a format change menu 931 to change the format of the text 914 may be displayed on the text block area 930 where the text 914 is copied. In some cases, if the title 915 is linked to the image 913 and the text 914, the title 915 may be automatically copied to the title area of the editing page 920 even if the title 915 is not selected separately (915′).

As illustrated in FIG. 9B, if the image 913 is touched on the web page 910 while the text 914 is already copied on the text block area 930, a GUI 941 indicating that the corresponding image 913 is selected may be displayed on the image 913.

Subsequently, if the selected image 913 is dragged to the area 914′ where the text 914 is copied, the corresponding image 913 may be automatically copied to the corresponding image block area 929. That is, even if a drag manipulation stops on the text block area 914′, the corresponding image 913 may be automatically copied to the image block area 929. In this case, the corresponding image 913 may be copied to the image block area 929 which is the closest to the location where a drag manipulation stops.

However, this is only an example, and if the image 913 and the text 914 are linked and the image block area 929 and the text block area 930 are linked, the corresponding image 913 may be automatically copied to the linked image block area 929 regardless of the image block area closest to the location where the drag manipulation stops. That is, even if the image block area closest to the location where the drag manipulation stops is not the image block area 929, the corresponding image 913 may be automatically copied to the image block area 929.

As illustrated in FIG. 10, if a plurality of objects are selected and copied simultaneously through a multi-touch and drag manipulation, the objects may be automatically copied to the corresponding areas based on the attributes of each of the plurality of objects.

Specifically, if the image 913 and the text 914 are selected through a multi-touch manipulation of touching each of the image 913 and the text 914, GUIs 943, 944 indicating that the corresponding objects are selected may be displayed.

Subsequently, in accordance with a multi-touch manipulation of dragging the selected image 913 and the selected text 914, the image 913 and the text 914 may be copied to the image block area 929 and the text block area 930 which are the closest to where the drag manipulation stops. In addition, if the title 915 regarding the image 913 and the text 914 is linked, the title 915 may be copied together with the image 913 and the text 914 through the multi-touch manipulation even if the title 915 is not separately selected.

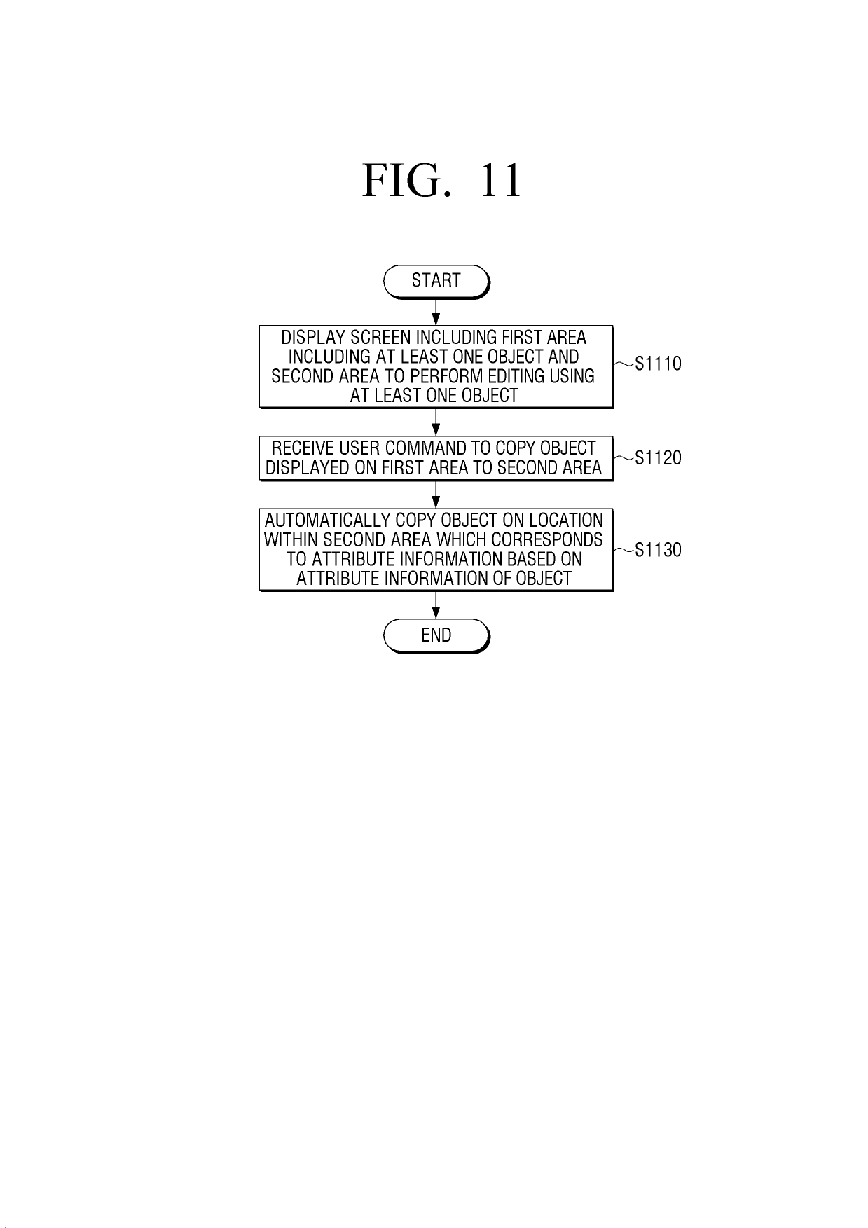

FIG. 11 is a flowchart provided to explain a method for controlling a user terminal apparatus according to an exemplary embodiment.

According to a method for controlling a user terminal apparatus illustrated in FIG. 11, first of all, a first image including at least one object and a second area including a screen to perform editing using the at least one object are displayed (S1110).

Subsequently, a user command to copy an object displayed on the first area to the second area is input (S 1120). Herein, the user command may be a user manipulation of touching an object and dragging it to the second area.

Subsequently, if the user command is input, the object may be automatically copied to a location within the second area which corresponds to the attribute of the object based on the attribute of the object (S1130).

Herein, the second area may include a plurality of block areas having different attributes. In addition, the attribute of an object may include at least one of image attribute, text attribute, list attribute, and moving image attribute.

In this case, in operation S1130 of automatically copying an object, if an object is moved to the second area according to a user command, the object may be automatically copied to a block area corresponding to the attribute of the object from among a plurality of block areas.

Each of a plurality of areas has predetermined format information, and if an object is automatically positioned on a block area, the format of the object may be changed and displayed according to the predetermined format information in the corresponding block area.

In operation S1130 of automatically copying an object, if an object is moved to an area within the second area which does not correspond to the attribute of the object according to a user command, the object may be automatically copied to an area corresponding to the attribute of the object.

In addition, in operation S1130 of automatically copying an object, if there are a plurality of block areas corresponding to the attribute of an object, the object may be automatically positioned on a block area closest to a location where the object is moved according to a user command.

In operation S1130 of automatically copying an object, if a plurality of objects which are selected simultaneously on the first area are moved to the second area according to a user command, the plurality of objects may be automatically copied to a plurality of block areas corresponding to the attribute of each of the plurality of objects.

In this case, a user command to select a plurality of objects may be one of a multi-touch input with respect to each of the plurality of objects and a touch input to select the scope including the plurality of objects.

As described above, according to the exemplary embodiments, the function of copying and pasting a plurality of objects in a touch-based device may be performed easily.

The controlling method according to the above-mentioned various exemplary embodiments may be realized as a program and provided to a user terminal apparatus.

For example, a non-transitory computer readable medium storing a program which performs displaying a first area including at least one object and a second area to perform editing using the at least one object, receiving a user command to copy an object displayed on the first area to the second area, and if the user command is input, automatically coping the object on a location within the second area which corresponds to the attribute of the object based on the attribute of the object may be provided.

Herein, the non-transitory recordable medium refers to a medium which may store data semi-permanently rather than storing data for a short time such as a register, a cache, and a memory and may be readable by an apparatus. Specifically, the above-mentioned various applications or programs may be stored in a non-transitory recordable medium such as a CD, a DVD, a hard disk, a Blu-ray disk, a USB, a memory card, and a ROM and provided therein.

The foregoing embodiments and advantages are merely exemplary and are not to be construed as limiting the inventive concept. The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A user terminal apparatus comprising:
a display unit which displays a screen including a first area including at least one object and a second area to perform editing using the at least one object;
a user interface unit which receives a user command to copy the object displayed in the first area to the second area; and
a controller which, in response to the received user command, controls to automatically copy the object to a location within the second area which corresponds to an attribute of the object based on the attribute of the object.

2. The apparatus as claimed in claim 1, wherein the second area includes a plurality of block areas having different attributes,
wherein the controller, if the object included in the first area is moved to the second area according to the user command, controls to automatically copy and position the object in a block area which corresponds to the attribute of the object from among the plurality of block areas.

3. The apparatus as claimed in claim 2, wherein each of the plurality of block areas has predetermined format information,
wherein the controller, if the object is automatically positioned on the block area, changes and displays a format of the object according to predetermined format information of a corresponding block area.

4. The apparatus as claimed in claim 2, wherein the user command is a user manipulation of touching the object included in the first area and dragging the object to the second area.

5. The apparatus as claimed in claim 2, wherein the controller, if the object is moved from the first area to a block area within the second area which does not correspond to an attribute of the object according to the user command, controls to automatically move and position the object in a block area of the second area which corresponds to the attribute of the object.

6. The apparatus as claimed in claim 5, wherein the controller, if there are a plurality of block areas which correspond to an attribute of the object, controls to automatically position the object in a block area closest to a location where the object is moved according to the user command.

7. The apparatus as claimed in claim 2, wherein the controller, if a plurality of objects which are selected simultaneously on the first area move to the second area according to the user command, controls such that each of the plurality of selected objects are positioned in each of a plurality of block areas having attributes corresponding to each of the plurality of objects, respectively.

8. The apparatus as claimed in claim 7, wherein the user command to select a plurality of objects is one of a multi-touch input with respect to each of the plurality of objects and a touch input to select a scope encompassing the plurality of objects.

9. The apparatus as claimed in claim 2, wherein an attribute of the object includes at least one of an image attribute, a text attribute, a list attribute, and a moving image attribute.

10. A method for controlling a user terminal apparatus, the method comprising:
displaying a screen including a first area including at least one object and a second area to perform editing using the at least one object;
receiving a user command to copy the object displayed in the first area to the second area; and
in response to the received user command, automatically copying the object to a location within the second area which corresponds to an attribute of the object based on the attribute of the object.

11. The method as claimed in claim 10, wherein the second area includes a plurality of block areas having different attributes,
wherein the automatically copying the object comprises, if the object is moved to the second area according to the user command, automatically copying and positioning the object in a block area which corresponds to the attribute of the object from among the plurality of block areas.

12. The method as claimed in claim 11, wherein each of the plurality of block areas has predetermined format information,
wherein the method further comprises, if the object is automatically positioned in the block area, changing and displaying a format of the object according to predetermined format information of a corresponding block area.

13. The method as claimed in claim 10, wherein the user command is a user manipulation of touching the object displayed in the first area and dragging the object to the second area.

14. The method as claimed in claim 11, wherein the automatically copying the object comprises, if the object is moved to a block area within the second area which does not correspond to an attribute of the object according to the user command, automatically moving and positioning the object in a block area which corresponds to the attribute of the object.

15. The method as claimed in claim 14, wherein the automatically copying the object comprises, if there are a plurality of block areas which correspond to an attribute of the object, automatically positioning the object to a block area closest to a location where the object is moved according to the user command.

16. The method as claimed in claim 11, wherein the automatically copying the object comprises, if a plurality of objects which are selected simultaneously on the first area move to the second area according to the user command, positioning each of the plurality of objects in each of a plurality of block areas having attributes corresponding to each of the plurality of objects, respectively

17. The method as claimed in claim 16, wherein the user command to select a plurality of objects is one of a multi-touch input with respect to each of the plurality of objects and a touch input to select a scope encompassing the plurality of objects.

18. The method as claimed in claim 11, wherein an attribute of the object includes at least one of an image attribute, a text attribute, a list attribute, and a moving image attribute.
